(19) United States
(12) Patent Application Publication
(10) Pub. No.: US 2013/0205186 A1
(43) Pub. Date: Aug. 8, 2013

(54) JamSciencePaper.Org

(71) Applicant: Mostafa SHAHEE, Famagusta (TR)

(72) Inventor: Mostafa SHAHEE, Famagusta (TR)

(21) Appl. No.: 13/364,784

(22) Filed: Feb. 2, 2012

(51) Int. Cl. G06F 17/00; G06Q 20/22; G06F 17/30

(52) U.S. Cl. 715/205; 705/39

(57) ABSTRACT

The present invention is an internet technology-based system (e.g., webpage) which allows users to search, restrict their quality of search, save their implemented searches to avoid future searching, and finally to make self-archiving of implemented searches. The system categorizes the scientific papers as theoretical and non-theoretical papers in all diciplines and fields of studies and notifies users for the most recent published papers as soon as their searches are saved.rela. These facilities are offered by an automated alarm system and a tool known as “Favorite Box”. Access to citations of theoretical papers is facilitated through an internal database which presents all theoretical papers or their respective citations in choronogical order. Access to citation of non-theoretical papers from all other journals is possible by allowing users to choose their favorite journals and implement their search procedure. This invention can be implemented through the use of an encoded computer readable medium.

### FIELD OF INVENTION

The present invention relates to online bibliographic databases to ease and facilitate the access to all pure theoretical and non-theoretical published literatures in all disciplines and fields of sciences, simultaneously, by a networking system. In addition it helps scholars to update and enhance their database content without any need for frequently search for their most favorite subjects.

### BACKGROUND OF THE INVENTION

Internet-based bibliographic databases are well known in many academic fields. They are valuable tools for scholars and researchers and serve them to be informed of the most current research in a particular branch and field of science. These databases contain bibliographical information on numerous articles from a variety of journals which allow users to search for articles by querying the database by author, subject or keyword. Oftentimes, additional search fields can also be searched. The search results are returned in the form of a list of articles. Each result contains a citation to the article so that the user can retrieve the article if so desired. More sophisticated databases usually provide an abstract of the article for review, and possibly a hypertext link to the article in an online journal. In addition, specifically in medicine, one of them provides an environment for scholars to rate and discuss about the quality of articles in related fields.

However, there are a number of drawbacks to the online bibliographic databases. While these databases serve well in their role as a search engine, they lack many other desirable functions. For instance, they suffer from disability to separate theoretical papers from non-theoretical ones. Given the fact that the scientific papers are published in many different journals, this takes a long time for researchers to read the abstract of all the related published papers to distinguish theoretical papers from non-theoretical ones if they desire to be informed about the most recent published theoretical papers, specifically when they do not know the name of author or the title of the paper.

Nevertheless providing a bibliographic database for researchers which collects all the links of theoretical papers, related to all diciplines and fields of sciences, which are classified based on the subjects and organised in choronogical order, will ease access of scholars to the most resent theoretical papers without any obligation for knowing the name of authors or the title of papers.

Another drawback with those databases is that the researchers are required to search the database frequently in order to keep themselves updated about the most recent published papers including theoretical or non-theoretical ones.

This needs a considerable time to spend to search for desirable papers specially when the authors' name and the title of the papers most of the time are unknown.

To overcome that problem, this invention propose a facility known as “Favorite Box” such that all scholars are able to choose their most interested fields, subjects and search for a keyword. As soon as a keyword is chosen and “Save Search” icon is clicked, an automated search engine will search all published papers and articles (in which this automated search initially will focus only on the title, abstract and keywords(but not limiting to) of the articles provided by authors) from all related journals and save a link into the “Favorite Box” and scholars will be notified by sending an email to their personal mailbox as soon as a new related paper is detected as well.

Another drawback with those databases refers to the quality of papers. As long as searching from database based on subjects will bring up all the papers irrespective to the quality of papers, this may waste the time of scholars and researchers while they are obliged to read at least the abstract of all found papers to choose the most interesting ones.

As long as the quality of journals is a good signal for the quality of submitted papers, scholars are given an option to select the most favorite journals at first (before conducting the search) so that afterwards any selected keywords will only be searched from those specified journals, not all of them.

Another shortage observed on the existing databases is that there is no clear distinction between institutional individual users and individual users, as well as temporary individual users and regular individual users such that some individual users have to spent plenty of money for buying the membership of those databases while they may not need to take advantage of all the facilities provided by the system.

The present invention provides two major types of membership including Institutional and Personal membership as follow to meet the demands of all kinds of users;

INSTITUTIONAL MEMBERSHIP which is the most powerful option to access all the facilities offered by the system including access to provided data base for theoretical papers as well as access to search tools to seek for non-theoretical papers and their related “FAVORITE BOX” to take benefit of automated update and self-archiving, while utilizing save search option for non-theoretical and theoretical papers, from a selected number/all fields of study and for a specified number of users. This type of membership is available on annually basis for all scientific and educational institutions.

PERSONAL MEMBERSHIP includes four types of membership including GOLD, PLATINUM, SILVER and BRONZE membership.

GOLD MEMBERSHIP provides the same facilities as for institutional membership but the main distinction from institutional membership is the number of users which herein the system serves only one user. Individuals must choose one fields of study for minimum price to be charged. Obviously they are able to increase the number of interested fields of study if they wish for an extra expense. The membership for gold members is provided on annually basis as well.

PLATINUM MEMBERSHIP provides accessibility only to designed search tools for non-theoretical papers and its related “FAVORITE BOX”, and in that sense, with the same scope as for gold members. The extent to which the platinum members can choose their field of study and the pricing terms and conditions is similar to gold members.

SILVER MEMBERSHIP provides accessibility only to the database provided for theoretical papers and its related “FAVORITE BOX”, and in that sense, with the same scope as for gold members. The extent to which the silver members can choose their field of study and the pricing terms and conditions is similar to gold members.

BORONZ MEMBERSHIP provides accessibility to either theoretical papers or non-theoretical papers and their respective “Favorite BOX” or both of them at the same time. Similar to the previous types of membership, users are able to access to papers related to more than one field of study, if they wish, in return for additional membership fees. The only distinction here is that the membership offered to temporary individuals is on monthly basis to avoid paying undesired expense.

### OBJECTS AND SUMMARY OF THE INVENTION

It is an object of the present invention to provide a network-based system for classifying a citation database in terms of their theoretical and non-theoretical approaches.

It is an object of the present invention to provide a network-based database which contains all the pure theoretical papers in all disciplines and fields of study and related search module to seek for desired papers from the selected fields of study.

It is another object of the present invention to provide a new and improved system and search module which allows users to conduct their searches for non-theoretical papers based on selected journals, fields and subjects of study in which they desire to focus on, in order to broaden their knowledge.

It is another object of the present invention to provide a box named as “Favorite Box” for users to send their favorite papers into it for self-archiving of the most desired papers in which their fields and subjects are already selected.

It is another object of the present invention to provide a facility to notify scholars about the most recent published papers in the fields and subjects that they already have chosen and send a direct link to the “Favorite Box” to avoid conducting a search frequently.

It is another object of the present invention to allow users to eliminate all or some of the links transferred to their Favorite Box.

It is another object of the present invention to provide a new and improved automated system to register the Institutional and Individual users distinctly.

It is another object of the present invention to provide a new and improved automated system to register the Individual users, sub-categorized, as Gold, Platinum, Silver and Bronze members.

It is another object of the present invention to provide a new and improved automated system to register the Gold, Platinum, Silver in annually basis and Bronze members in monthly basis.

All the objects of the present invention can be achieved by providing a system for locating a scholarly content which compromises a server to a database wherein the database contains citation data of the scholarly contents in which users are able to access to the server via a network. In addition a search module include on the server to allow users to investigate the internal database (theoretical papers) as well as external databases (non-theoretical papers) in accordance to the search criteria embodied by the system users.

### BRIEF DESCRIPTION OF THE DRAWINGS

The present figures illustrate one or more applications of present invention in which together with the detailed description explains the principles and all aspects of the invention. These drawings pertain to all the fields of science.

FIG. 1 is a generalized flowchart of method of processing of access to the present invention.

FIG. 2 Shows a more particularized flowchart of method used to gain access to a system according to present invention.

FIG. 3 Shows the homepage used by users to connect with the present invention.

FIG. 4 is designed for institutional registration purposes.

FIG. 5 Shows different membership options provided for individual users.

FIG. 6 is designed for individual users to register as a gold member.

FIG. 7 is designed for individual users to register as a platinum member.

FIG. 8 is designed for individual users to register as a silver member.

FIG. 9 is designed for individual users to register as a bronze member.

FIG. 10 Shows a sample of a search result from a database provided for theoretical papers.

FIG. 11 Shows a sample of a search result for non-theoretical papers from all related journals as well as personal webpage of authors.

FIG. 12 is designed for all users to restrict their search to some specific journals if they desire so.

FIG. 13 Shows a sample of search results in [00031] which are sent to favorite box for self-archiving purposes.

FIG. 14 Shows a sample of search results in [00032] which are sent to favorite box for self-archiving purposes.

FIG. 15 shows payment amount and different methods of payments for users.

### DETAILED DESCRIPTION

The applications of present invention are herein described in the context of an online system to facilitate access to the scientific papers categorized as theoretical and non-theoretical ones. It should be noted that the detailed description of the present description is illustrative and is not intended to be limiting. The embodiments of the present invention will result that the skilled users take advantage of this invention.

To implement this invention, various types of operating systems, computer programs and related machines to link the components, process steps and data structures are used. In addition, devices such as hardwired devices, field programmable gate arrays (FPGA), application specific integrated circuits (ASIC) and . . . maybe used without departing from scope of novelty of present invention.

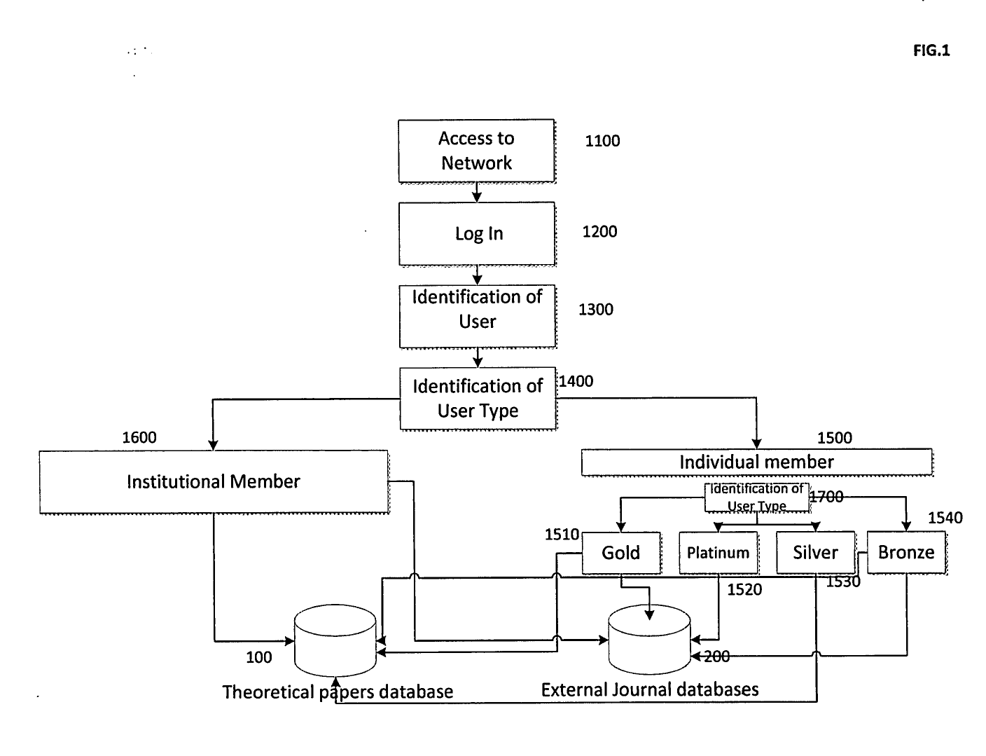

A generalized flowchart used to access to the present invention is shown if FIG. 1. Starting point is 1100 where a user connects to the system through internet. In second step 1200, when the user logs on, the identification process takes place. Successful identification process leads to the next step, 1400, where the user type must be recognized as well to allow user to access to the services provided by the system. In this step two types of users are recognized. Individual user, 1500; institutional user, 1600. If institutional user, he/she is allowed to access to theoretical paper database 100 as well as journals citation 200. If individual user, another identification process takes place 1700; to identify whether the user is Gold member, 1510, Platinum member, 1520, Silver member, 1530, and Bronze member, 1540. Gold and Bronze members are allowed to access 100 and 200, Platinum members are allowed to access to 200 and Silver members are allowed to access to 100.

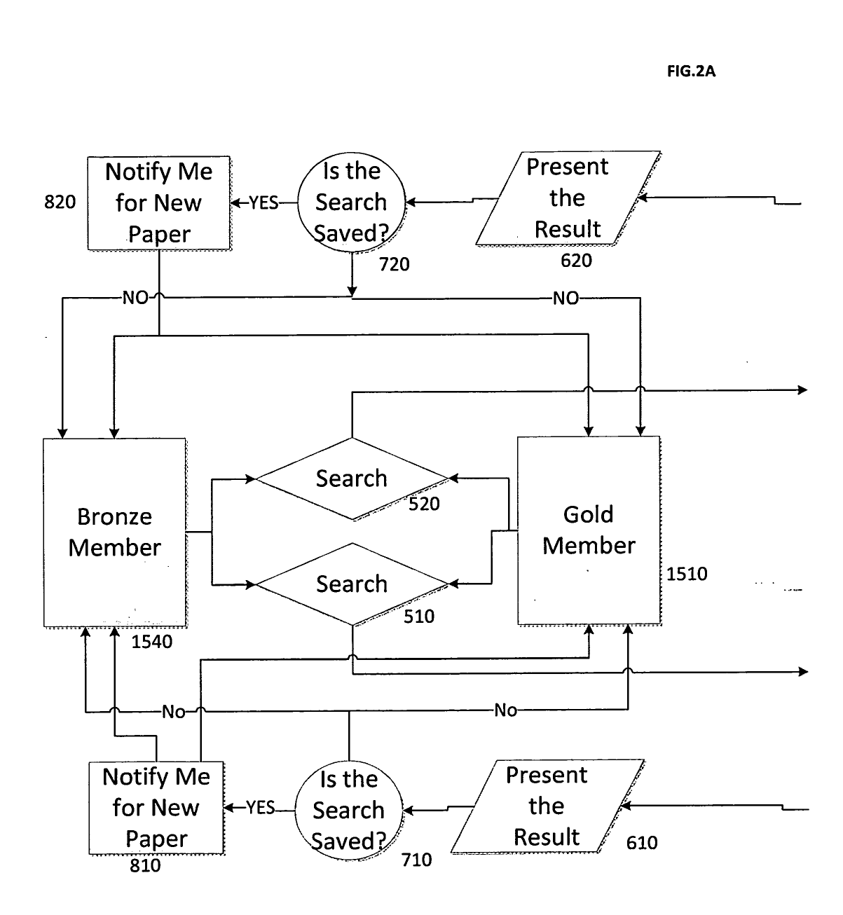

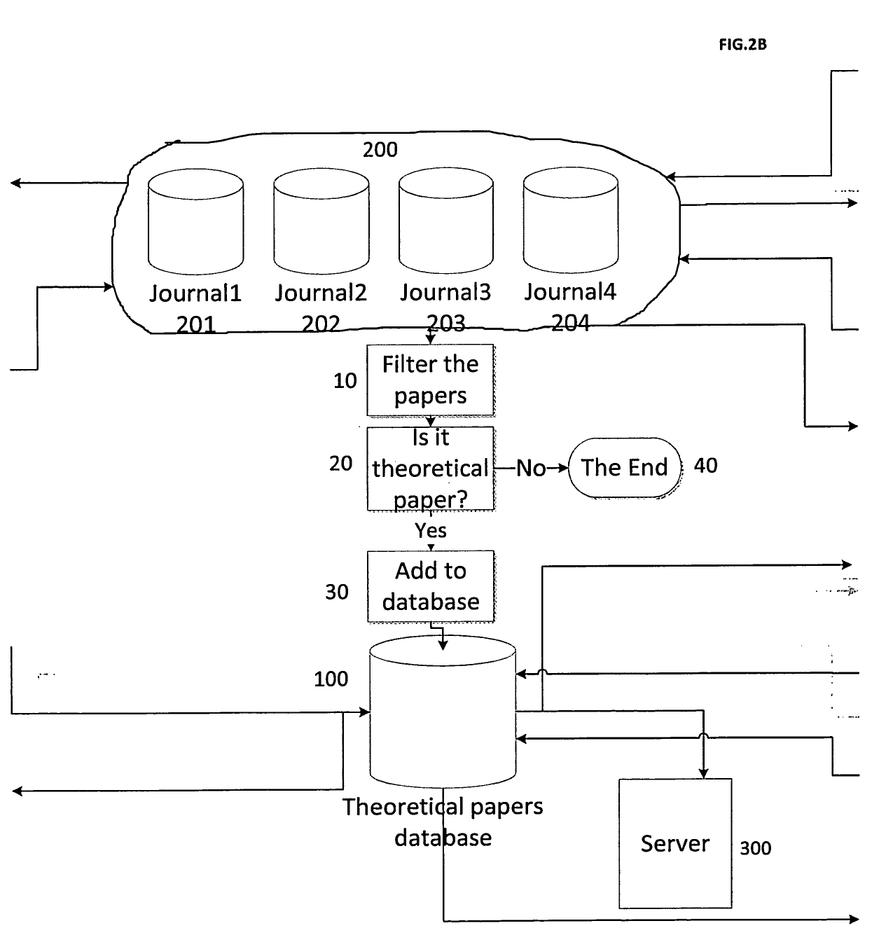

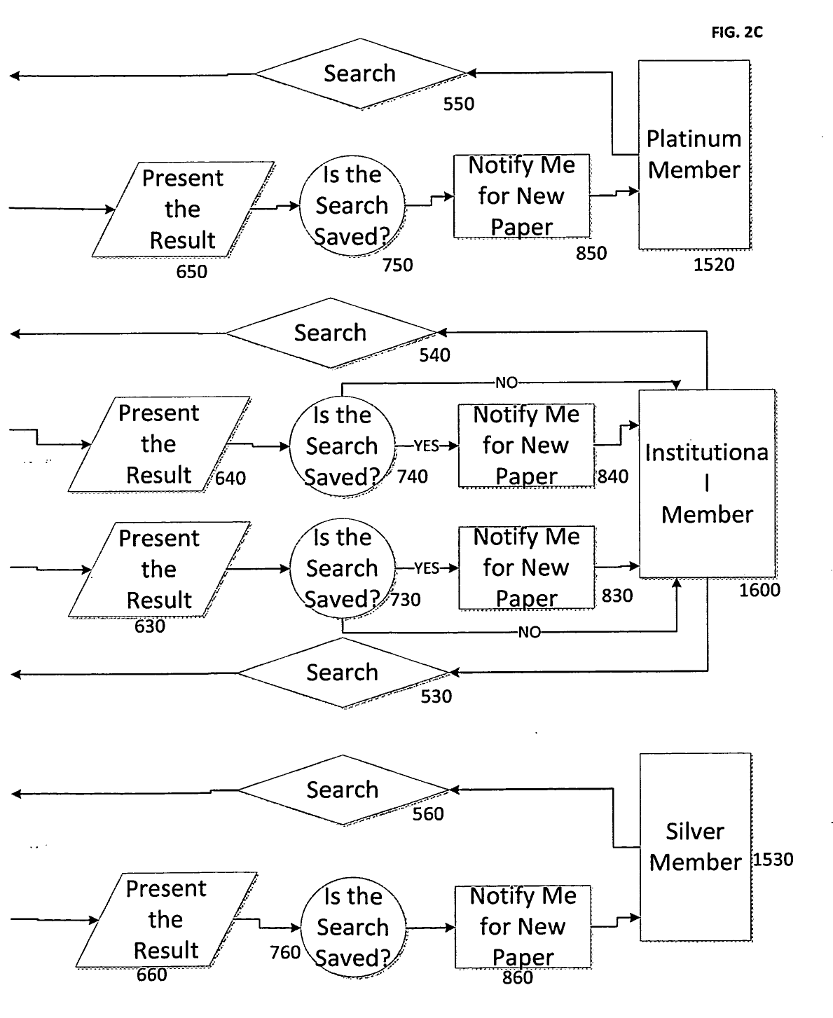

FIG. 2 shows more particularized flowchart used to clear how the system functions as soon as process

is implemented. As the figure exerts, the internal theoretical paper database, 100, is linked to the database of journals, 200. This process is done to filtering the papers, 10. If the paper is theoretical, 20, the next step, 30, would be adding it to internal database, 100. If not, the process will stop there, 40. The next step starts as the user enters to the system. If the user is identified as gold user, 1510, he/she would be able to benefit all services offered by the system. If he/she conducts a search, 510, from theoretical paper database, 100, the result will be presented to him/her 610. In the next step, 710, if he/she saves the search word, the system will notify him/her for new papers, related to search word, added to the database in the future, 810. If he does not save the search word, the process will end at, 710. If the gold user plans to take advantage of present invention to access to citation of other journals, 200, he/she is eligible to conduct a search, 520, using a keyword and the result will be presented to him/her, 620. In the next step, 720, if he/she saves the search word, the system will notify him/her for new papers, related to search word, published in all selected journals by him/her, 820. If he/she does not aim to save the search the process will end up at 720.

The procedure for bronze member, 1540, is the same considering that bronze member is obliged to choose either access to 100 or 200.

If the user is identified as platinum member, 1520, he/she is only obliged to access 200. After conducting the search, 550, the result will be presented to him/her, 650. In the next step, 750, if the search is saved, the user will be notified for new paper published in the selected journals, 850. If the search is not saved the process will end at, 750.

If the user is identified as silver member, 1530, he/she is only obliged to access 100. After conducting the search, 560, the result will be presented to him/her, 660. In the next step, 760, if the search is saved, the user will be notified for new paper published in the selected journals, 860. If the search is not saved the process will end at 760.

If the user is identified as institutional user 1600, it would be able to benefit all services offered by the system. If the search is conducted, 530, from theoretical paper database, 100, the result will be presented to him/her 630. In the next step 730, if the search is saved, the system will notify the user for new papers, related to search word, added to the database 100 in the future 830. If the search is not saved, the process will end at 710. If this user plans to take advantage of present invention to access to citation of other journals 200, the user is eligible to conduct a search, 540 and the result will be presented to user, 640. In the next step, 740, if the search is saved, the user will be notified for new papers, related to search word, published in all selected journals by him/her, 840. If the search word is not saved the process will end up at 740.

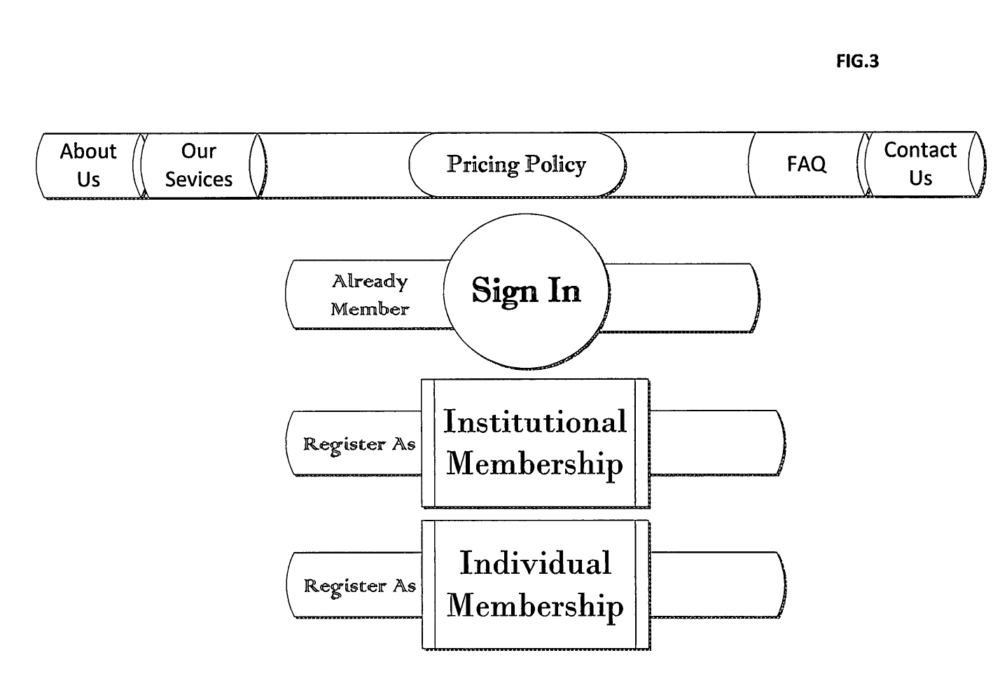

FIG. 3 shows a typical homepage for a website titled as JamSciencePaper.org. This page as a starting point for the users, to take advantage of the present invention, hosted a head bar which provides basic but necessary information for the users including a brief summary about the aim of the website, our services, pricing policy, frequently asked question as well as contact information. In addition it directs the users to the system in case they are already registered in the system by clicking on “sign in” icon and leads the first entrants to the related page to register to the system if they desire so.

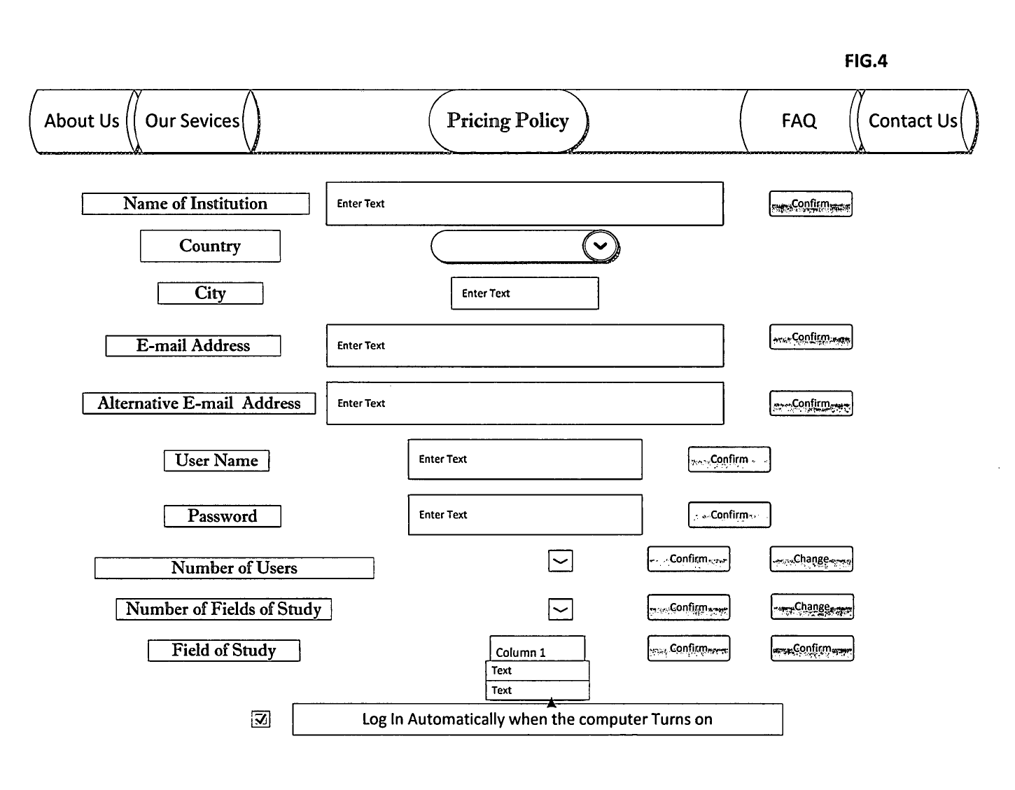

FIG. 4 shows a typical registration page provided for institutional users whereas users are obliged to provide their name, country and city where they reside, an email address and an alternative email address as well as private username and password. In addition they are able to choose number of users and name of fields that they desire to access to its related papers. After finishing each step, it is necessary to push confirm bottom to get confirmation from the system. The provided username and password by users are temporarily for a short period of time. As soon as the payment is finalized by users, an official username and password will be sent to the email address provided by them so that from then on they are obliged to use official username and password to take advantage of the system and the temporarily username and passwords will be suspended as soon as the official ones are used. Moreover an additional option is provided for the users in which by check-marking that the users will be automatically log in as computers turns on. The institutional users are by default gold member such that they can take benefit from all services provided by the present invention.

FIG. 5 is designed for individual users to choose one type of membership to suffice their needs including Gold, Platinum, Silver and Bronze memberships.

As a complement explanation for [00043], the gold membership allows users to benefit from all services provided by the present invention. This includes access to database for theoretical papers as well as citation for non-theoretical papers in addition to their related favorite box, to ease self-archiving. In this case the membership is defined on annually basis.

As a complement explanation for [00043], the platinum membership allows users to benefit from a partial services provided by the present invention. This includes only access to the citation for non-theoretical papers in addition to its related favorite box, to ease self-archiving. The membership here similar to previous case is defined on annually basis.

As a complement explanation for [00043], the silver membership, similar to previous case, allows users to benefit from a partial services provided by the present invention. This only includes access to database for theoretical papers in addition to its related favorite box, to ease self-archiving. The membership here is defined on annually basis as well.

As a complement explanation for [00043], the bronze membership, similar to previous case, allows users to benefit from a partial services provided by the present invention. This includes either access to database for theoretical papers or access to citation for non-theoretical papers in addition to their related favorite box, to ease self-archiving. The main difference here is referred to the membership type in which here is defined to be on monthly basis for temporarily individual users.

Clicking on each related icon will direct the individual users to respective registration webpage.

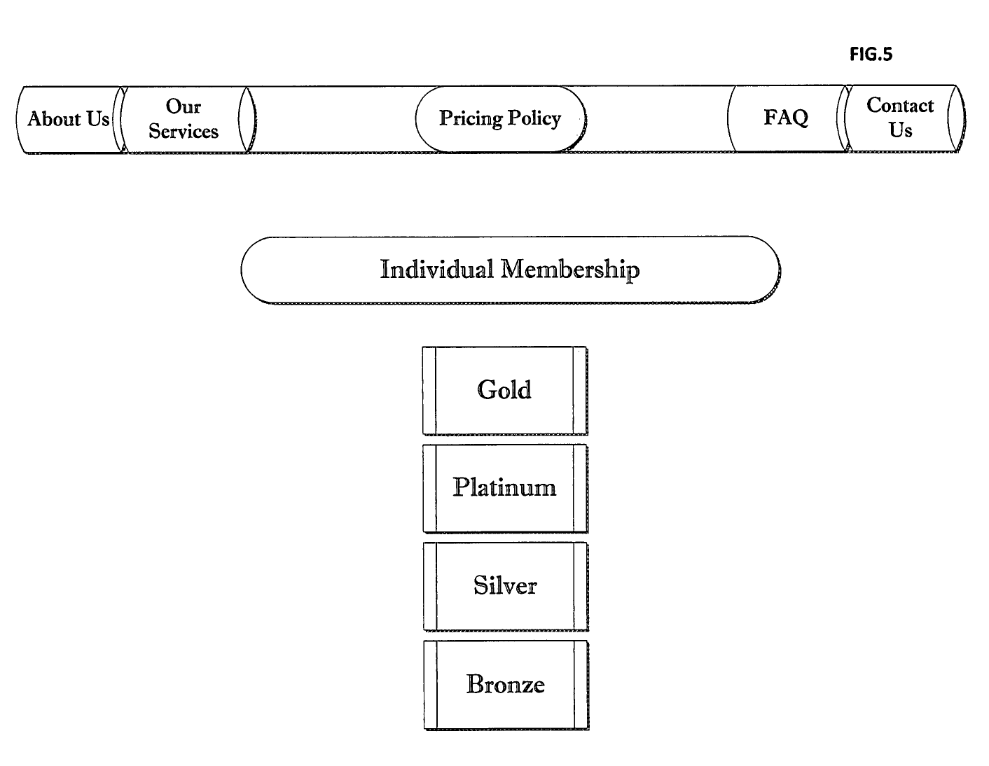

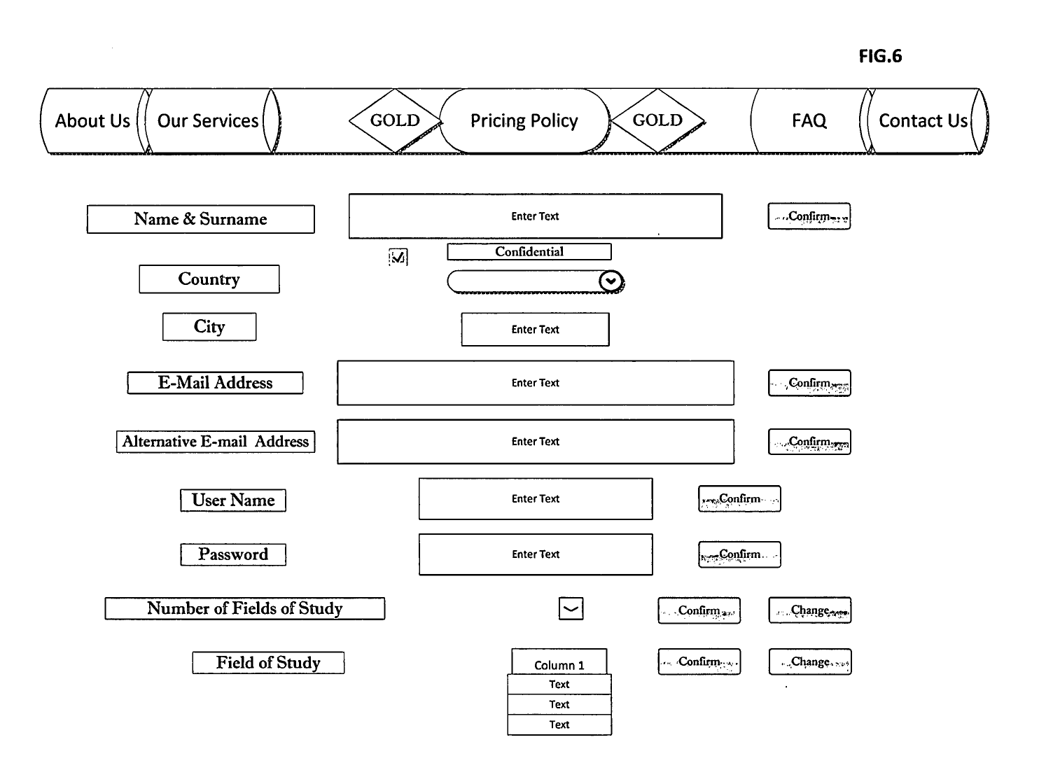

FIG. 6 shows a typical registration page provided for individual gold users hosting a head bar as in

whereas users are obliged to provide their name, country and city where they reside, an email address and an alternative email address as well as private username and password. In addition they are able to choose the number and name of fields that they desire to access to related papers. After finishing each step, it is necessary to push confirm bottom to get confirmation from the system. The provided username and password by users are temporarily for a short period of time. As soon as the payment is finalized by users, an official username and password will be sent to the email address provided by them so that from then on they are obliged to use official username and password to take advantage of the system and the temporarily username and passwords will be suspended as soon as the official ones are used. Although by default the name and surname of all individual users are kept confidential, the users are able to permit the system to disclose it by unmarking the related checkbox designed for this purpose.

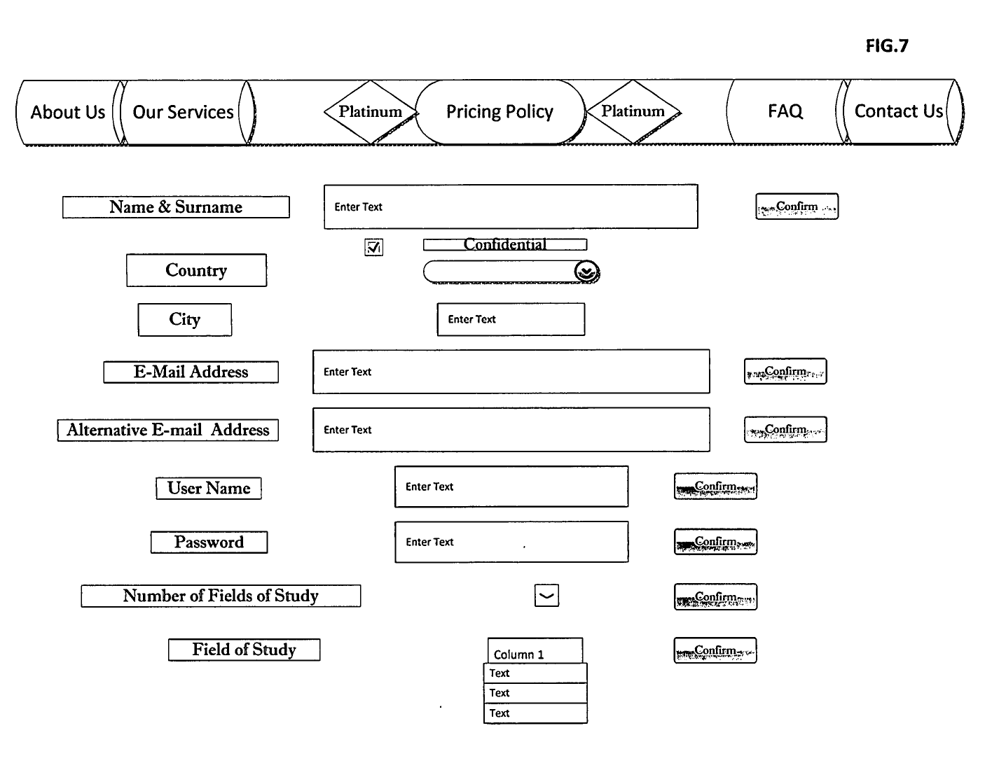

FIG. 7 shows a typical registration page provided for individual platinum member users whereas users are obliged to provide their name, country and city where they reside, an email address and an alternative email address as well as private username and password. In addition they are able to choose the number and name of fields that they desire to access to related papers. After finishing each step, it is necessary to click confirm bottom to get confirmation from the system. The provided username and password by users are temporarily for a short period of time. As soon as the payment is finalized by users, an official username and password will be sent to the email address provided by them so that from then on they are obliged to use official username and password to take advantage of the system and the temporarily username and passwords will be suspended as soon as the official ones are used. Although by default the name and surname of all individual users are kept confidential, the users are able to permit the system to disclose it by unmarking the related checkbox designed for this purpose.

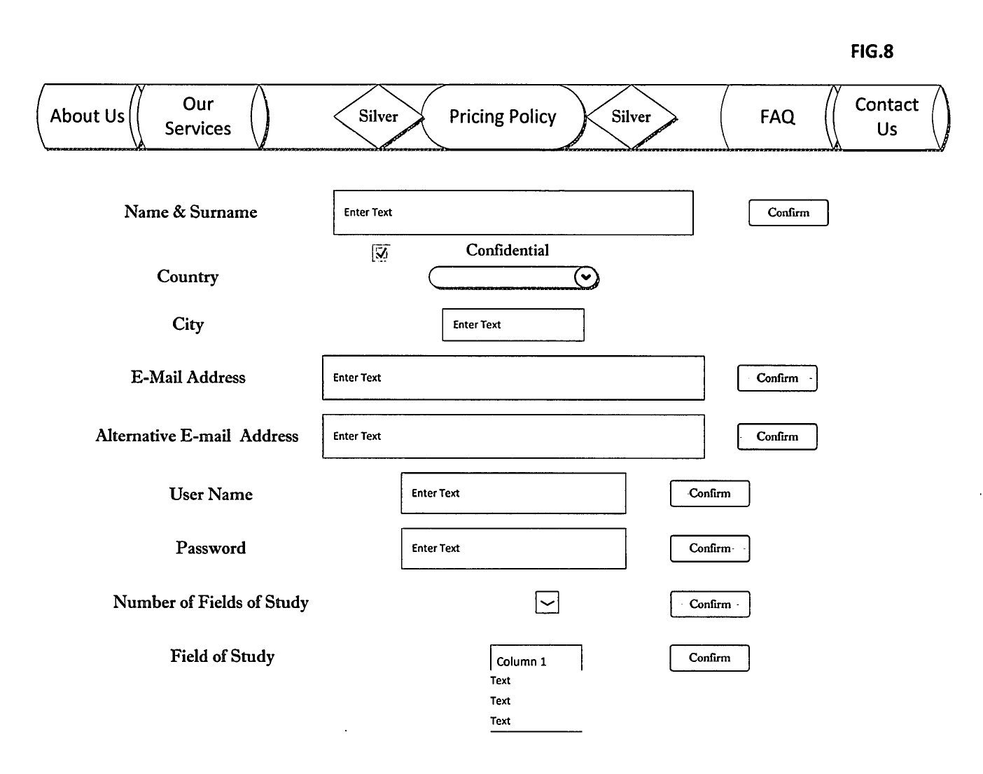

FIG. 8 shows a typical registration page provided for individual silver users whereas users are obliged to provide their name, country and city where they reside, an email address and an alternative email address as well as private username and password. In addition they are able to choose the number and name of fields that they desire to access to related papers. After finishing each step, it is necessary to push confirm bottom to get confirmation from the system. The provided username and password by users are temporarily for a short period of time. As soon as the payment is finalized by users, an official username and password will be sent to the email address provided by them so that from then on they are obliged to use official username and password to take advantage of the system and the temporarily username and passwords will be suspended as soon as the official ones are used. Although by default the name and surname of all individual users are kept confidential, the users are able to permit the system to disclose it by unmarking the related checkbox designed for this purpose.

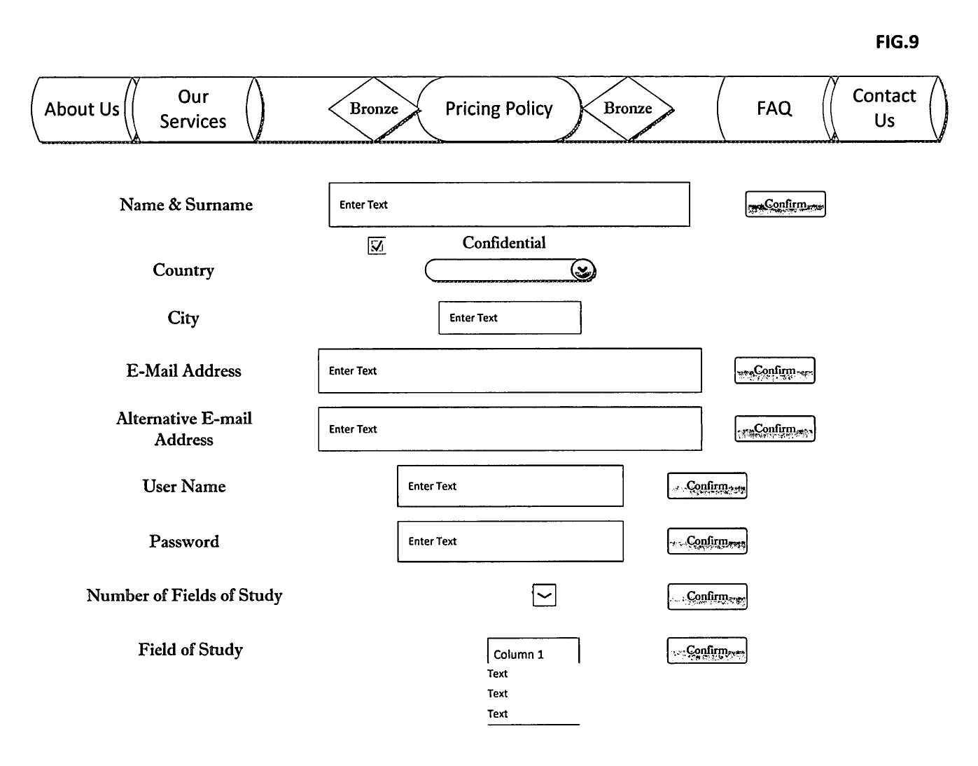

FIG. 9 shows a typical registration page provided for individual bronze users whereas users are obliged to provide their name, country and city where they reside, an email address and an alternative email address as well as private username and password. In addition they are able to choose the number and name of fields that they desire to access to related papers. After finishing each step, it is necessary to push confirm bottom to get confirmation from the system. The provided username and password by users are temporarily for a short period of time. As soon as the payment is finalized by users, an official username and password will be sent to the email address provided by them so that from then on they are obliged to use official username and password to take advantage of the system and the temporarily username and passwords will be suspended as soon as the official ones are used. Although by default the name and surname of all individual users are kept confidential, the users are able to permit the system to disclose it by unmarking the related checkbox designed for this purpose.

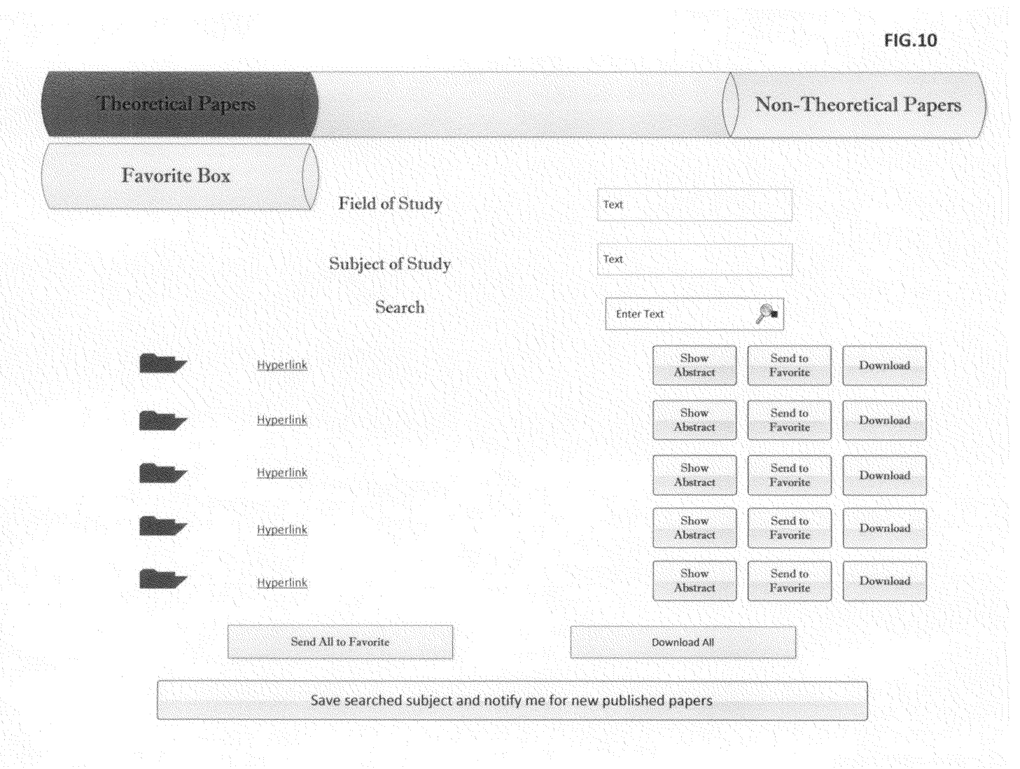

FIG. 10 shows a typical database search result page for theoretical papers. As it is exerted the field of study which is already chosen in [00042], [00048],[00050] and[00051] along with another sub-classification of fields of study provided as subject of study, are shown by default. This page houses a search bar which allows the users to search the citation database for a keyword. The results are presented in chorological order and in front of each link there are three options as “Show Abstract”, “Send to Favorite Box” and “Download”. These options facilitate access to the most desired papers for scholars. All the papers are downloadable at this stage by clicking on “Download” icon or their related link can be sent to favorite box for self-archiving or future downloading, by clicking on “Send to Favorite Box” icon. Also users are able to download or send all papers to the favorite box at the same time.

Moreover there is another icon herein known as “ Save searched subject and notify me for new published paper” in which clicking on that icon will save the search keyword and send a link of future publishing related theoretical papers to the favorite box as well as an email to email address provided by users in registration stage.

This idea allows scholars not to search for their desired topics frequently but only once such that the system automatically updates their search result and will notify them via them via sending a link to their favorite box and a message to their personal mailbox as soon as a new paper is added to the internal database.

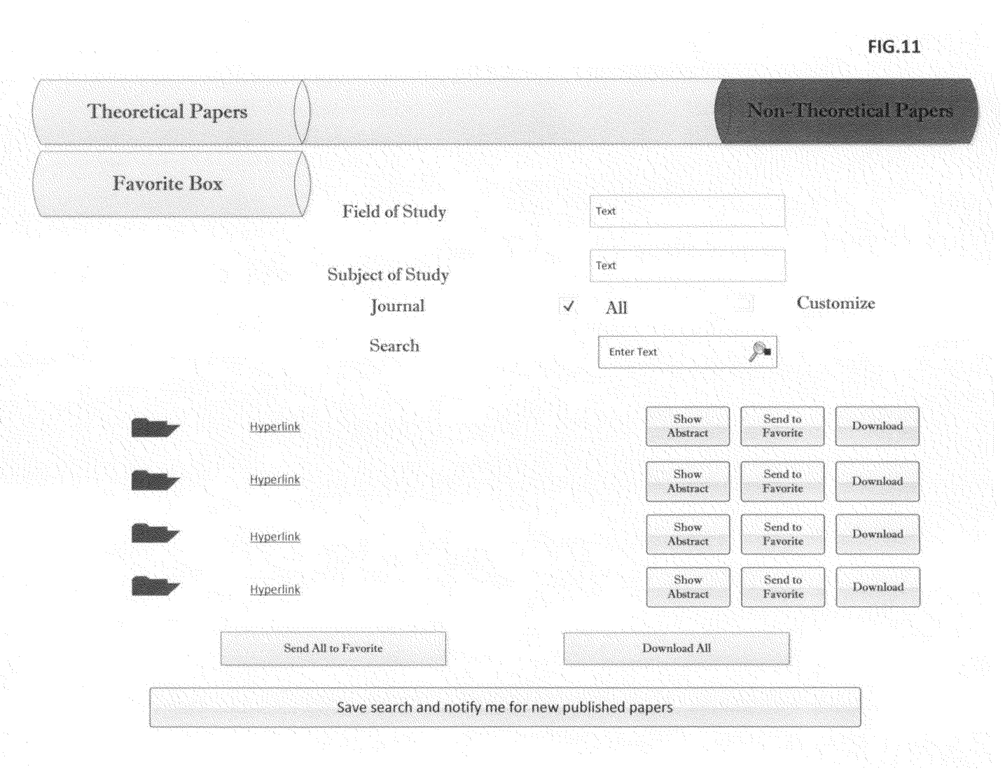

FIG. 11 shows a typical citation search result page for non-theoretical papers. As it is exerted the fields of study which is already chosen in [00042], [00048], [00049], [00051] is shown by default and users are given an option to choose all journals or restrict the number of journals as they desire. In addition they are required to type the keyword to implement their searching process. The results are presented in the order of selected journals and in front of each link there are three options as “Show Abstract”, “Send to Favorite Box” and “Download”. These options facilitate access to the most desired papers for scholars. In addition all the papers are downloadable at this stage, by clicking on “Download” icon, or their related link can be sent to favorite box for self-archiving or future downloading, by clicking on “Send to Favorite Box” icon. Also users are able to download or send all papers to the favorite box at the same time.

Moreover there is another icon herein known as “ Save search and notify me for new published paper” in which clicking on that will save the search keyword and send a link of future publishing related non-theoretical papers to the favorite box as well as an email to email address provided by users in registration stage from the selected journals.

This idea allows scholars not to search for their searched topics in future frequently but only once, such that the system automatically updates their search result and will notify them via sending a link to their favorite box and a message to their personal mailbox as soon as a new paper is published on selected journals.

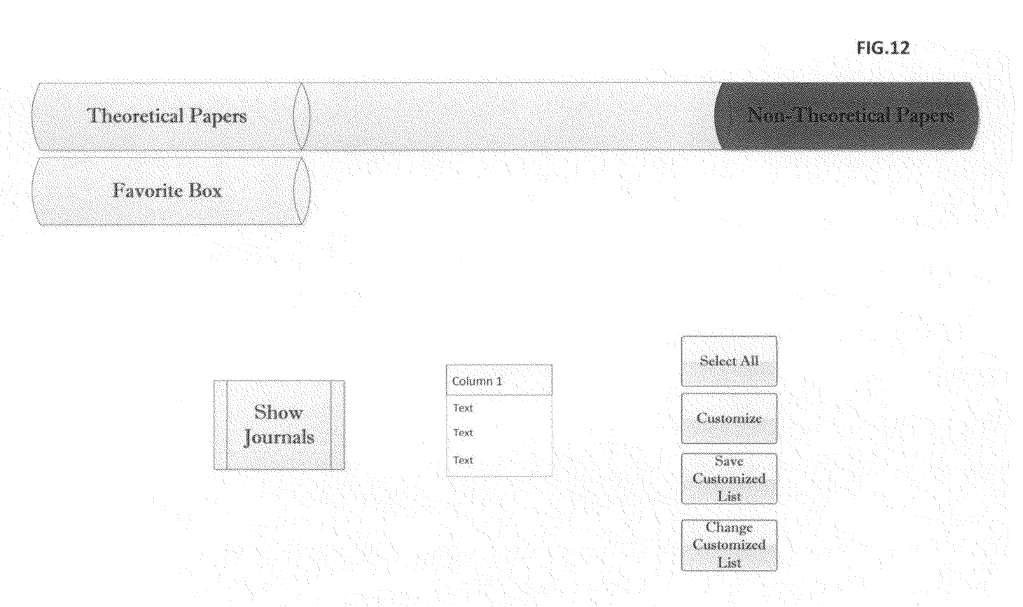

FIG. 12 shows customized page of journals in case users are willing to restrict the number of journals for current and future searching through non-theoretical papers. Users are able to customize and save or even change the saved customized list at any time they wish so.

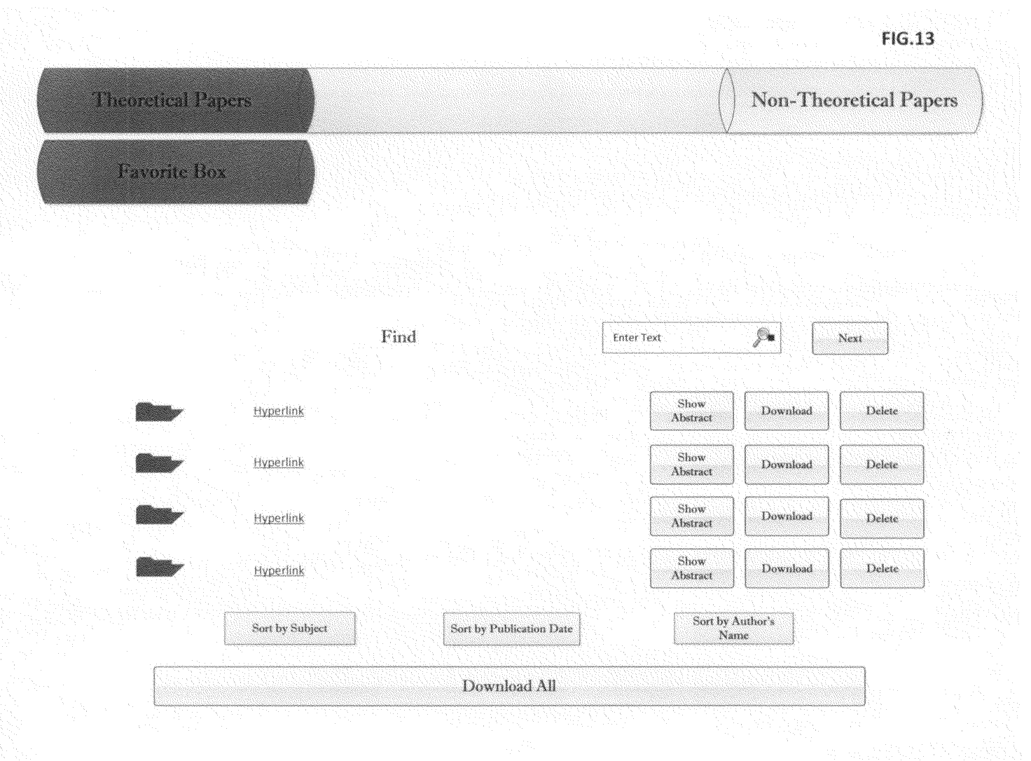

FIG. 13 shows a typical favorite box designed for theoretical papers. As soon as clicking on this box, users are able to utilize it. It includes the link of papers which are already sent to this box and allows users to view the abstracts of papers to download or delete them from the favorite box. In addition it provides options to sort the papers by subject, date of publication as well as authors' name. Moreover “Find” option is designed to ease searching for specific keyword in title or abstract of papers and “Download All” allows users to download all papers at the same time.

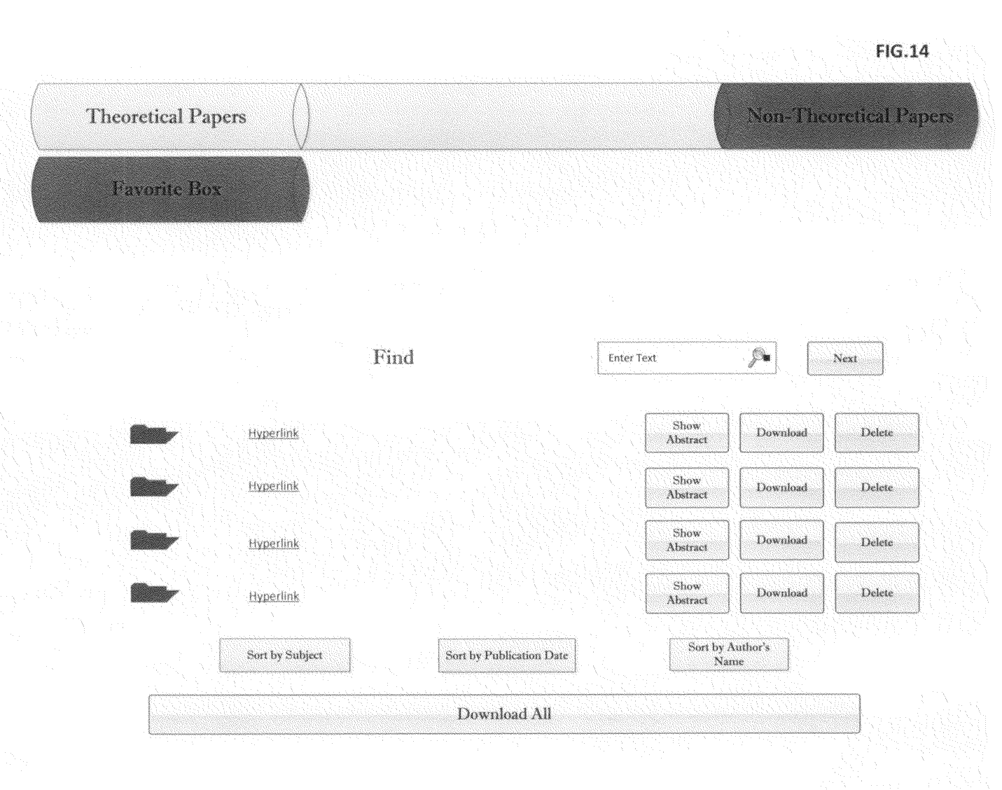

FIG. 14 shows a typical favorite box designed for theoretical papers. As soon as clicking on this box, users are able to utilize it. It includes the link of papers which are already sent to this box and allows users to view the abstracts of papers to download or delete them from the favorite box. In addition it provides options to sort the papers by subject, date of publication as well as authors' name. Moreover “Find” option is designed to ease searching for specific keyword in title or abstract of papers and “Download All” allows users to download all papers at the same time.

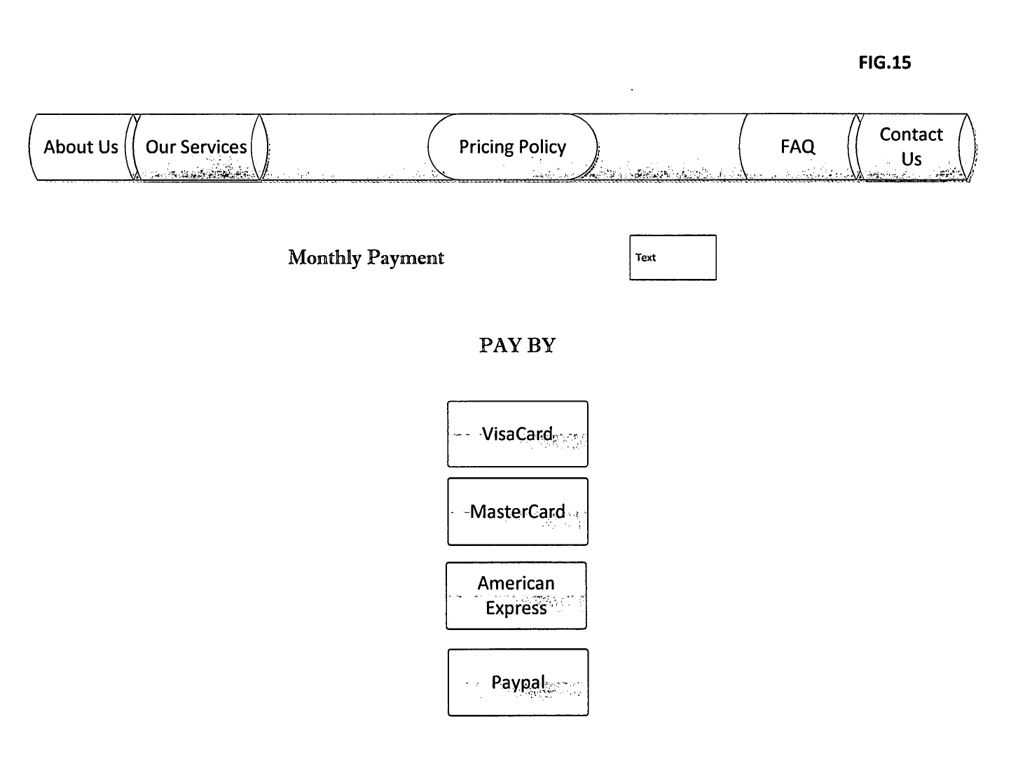

FIG. 15 shows the related page to finalize the service fees. Monthly payment is shown on top of the page in accordance to chosen number of fields in [00042], [00048], [00049], [00050] and [00051]. Clicking on any types of payment will direct users to the related page to finalize the payment.

1. A method of classifying and identifying scientific papers compromising:
a. A system for locating pure theoretical papers in a database which compromises a server to the database in which users are able to access it via a network using a search module, while the results are displayed on the screen as hyperlink citation, and a mechanism to save implemented searches to avoid future searching;
b. A system to allow users to seek for all non-theoretical papers from all scientific journals and personal webpages in the fields and subjects of the interest, while the results are displayed as hyperlink citation, and a mechanism to save implemented searches to avoid future searching; and
c. A “Favorite Box” designed for self-archiving in which allows users to send their favorite papers into it and to be notified through a notification alert mechanism as soon as a new paper, related to the saved search, is added to provided database or is published in other journals in addition to a notification email which will be sent to their personal mailbox.

2. A method of claim 1(a): wherein the theoretical papers are sorted in accordance with the field of study, the subject of the study and in alphabetical order wherein the papers related to each subject, while displaying their titles, are sorted in chronological order (date of publication).

3. A method of claim 1(a): wherein the abstract of each paper, in addition to its title, can be shown and the paper itself can be retrieved by clicking on respective icons (if the paper is open access) and the user will be directed to the related webpage (if the paper is not open access).

4. A method of claim 1(a): wherein the “Favorite Box” is designed for self-archiving of theoretical papers, “Send to Favorite” icon is designed to send favorite papers to it.

5. A method of claim 1(a): wherein “save search and notify me for new published paper” is designed to save searches conducted by users and notify them for the last update of theoretical papers database.

6. A method of claim 1(a): wherein icons of “Download All” and “Send All to Favorite” are designed to download or send all shown papers to “Favorite Box” successively for self-archiving.

7. A mechanism to update the database of pure theoretical papers frequently.

8. A method of claim 1(b): wherein the field of the study, selected in the registration stage, which is classified in accordance with subject, is shown automatically.

9. A method of claim 1(b): wherein “Show Journals” icon is designed to show the list of all related journals related to the selected field of study to allow users to select the list of journals for conducting efficient search, “Select All” icon is designed for users to select all shown journal as a source of searching and the “Customize”. icon is designed for users to pick up the most favorite journals as a source of future searching.

10. A method of claim 1(b): wherein, “Save Customized” icon is designed for saving the customized journals for future searching and the “Change Customized List” is designed for the ease of any desirable change in customize setting.

11. A method of claim 1(b): wherein the “Show Abstract” icon is designed in front of the citation hyperlink of each paper to show the abstract of it, while clicking on that icon, and “Download” icon next to the “Show Abstract” icon is designed to download the paper in case it is retrieved from an open access journal or webpage. Also “Delete” icon is designed next to that to eliminate undesired papers simultaneously.

12. A method of claim 1(b): wherein a mechanism will direct the users to the homepage of journals to ease citation in case the desired paper is not an open access one.

13. A method of claim 1(b): wherein “Favorite Box” is designed for self-archiving, the “Send to Favorite” is designed to send favorite papers to “Favorite Box”, and wherein the icons of “Download All” and “Send All to Favorite” are designed to download all at that stage or send all the shown papers to “Favorite Box” successively.

14. A method of claim 1(b): wherein “save search and notify me for new published paper” is designed to save searches conducted by users and notify them for the last published non-theoretical papers in the selected journals through sending a link to favorite box and an email to users' personal mailbox.

15. A method of claim 1(c); wherein a “Show Abstract”, “Download” and “Delete” icons are designed and located in front of each link transferred into the favorite box.

16. A method of claim 1(c); wherein “Sort by Subject” is designed to ease sorting papers in accordance to subject, “Sort by Publication date” is designed to ease sorting papers in accordance to publication date and “Sort by Authors' Name” is designed to ease sorting papers in accordance to the authors' name.

17. A method of claim 1(c) wherein; “Download All” is designed to ease retrieving all papers at the same time and successively.

18. A method of annually payment for institutional users based on the chosen number of fields of study as well as the number of users as explained in [00010].

19. A method of annually payment for individual users based on the chosen number of fields of study as explained in [00010].

20. A method of monthly payment for temporary users (Bronze Users) based on the chosen number of fields of study as explained in [00010].
